(19) United States
(12) Patent Application Publication
(10) Pub. No.: US 2008/0161053 A1
(43) Pub. Date: Jul. 3, 2008

(54) Portable communication device with dual configuration storage and the method for the same

(75) Inventor: Kuang Hsun Hsieh, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/902,016

(22) Filed: Sep. 18, 2007

(30) Foreign Application Priority Data
Dec. 28, 2006 (TW) 095149540

(51) Int. Cl. H04M 1/02

(52) U.S. Cl. 455/558

(57) ABSTRACT

The present invention discloses a portable communication device with a dual configuration storage unit comprising a master storage unit and a backup storage unit. A flash memory is utilized therein as a storage medium. Because the flash memory is easily corrupted and may have bad blocks situations, the dual configuration blocks technology similar to mirror reflecting is utilized to reduce the risk of data corruption and bad blocks on the flash memory. The backup storage unit may store identical data to those in the master storage unit. When data in the master storage unit are corrupted, data recovery may be performed by using the backup storage unit.

### FIELD OF THE INVENTION

The present invention relates to a portable communication device, and more particularly, to a portable communication device with a dual configuration storage unit.

### BACKGROUND OF THE INVENTION

A conventional mobile phone has single storage unit only for storing system setting information, system information, multimedia service information, and personal information such as address books, telephone numbers, and calendars. The mobile phone collects voice communication data through an analog-to-digital converter (ADC) and sends data messages of the voice call signal by using protocols such as CDMA (Code Division Multiple Access), W-CDMA (Wideband CDMA), and GPRS (General Packet Radio Service). The signal is transmitted by a transmitter of the mobile phone, followed by receiving by the signal receiver of the remote terminal. A digital-to-analog converter converts the digital signal into an analog signal after the receiver receives the digital signal so as to allow the user to understand the data messages transmitted from the other party.

Under conventional mobile phone technology, a system will enter a normal use mode and read data in a storage unit of the mobile phone after the mobile phone powers up. When the system fails to read the data, an error message will be generated to indicate the failure of the situation automatically, thereby informing the user that the data corruption occurs in the system.

Meanwhile, the mobile phone system will instruct the user to manually reset boot-up system information concerned with the storage unit configuration to recover original boot-up system files of the mobile phone. If the user fails to complete system configuration settings of the storage unit after repeating above manual resetting steps several time, causing that the mobile phone is under abnormal status, it refers that there may be bad blocks in the hardware of the storage device unit. At this time, the only solution for the mobile user is to call help to the service supplier and request the service of checking and repairing.

Therefore, configuration information of the storage unit in the mobile phone may be lost and crashed by some uncertain events. It causes that the information in the storage unit configuration is missing.

Accordingly, current storage technology still has many defects based on the above conventional technology. A new technology solution is extremely needed to recover configuration data of the mobile phone effectively when the configuration data of the mobile phone are corrupted or bad blocks are found in the storage device unit.

### SUMMARY OF THE INVENTION

In view of the above background, the problem of unrecoverable important data in the portable communication device is unlikely to be saved. Based on the above requirement, the present invention discloses a portable communication device with a dual configuration storage unit including a master storage unit and a backup storage unit.

The main purpose of the present invention is to provide the portable communication device with the dual configuration storage unit. After the above portable communication device boots up, the backup storage unit copies configuration information in the master storage unit into itself if configuration information in the master storage unit has corruption error so as to backup boot-up operations of the portable communication device performed in the storage unit. When the blocks in the master storage unit are corrupted, the backup storage unit will be activated to replace the master storage unit to restart boot-up procedures.

The portable communication device disclosed in the present invention includes a microprocessor arranged in the portable communication device; a dual configuration storage unit embedded in the microprocessor, including a master storage unit and a backup storage unit to store data in the microprocessor; a microprocessor coupled to the operating system; a Phone UI application module coupled to the operating system for a user to input instructions; dual configuration MTD driver modules installed in the operating system as communication between the Phone UI application module and the dual configuration storage unit; a converter arranged in the portable communication device as conversion between an analog signal and a digital signal; a voice engine coupled to the operating system as a transmission medium of the analog signal and the digital signal; and a call controller coupled to the voice engine to communicate with the Phone UI application module through instructions and events, wherein the device may further include WiFi (Wireless Fidelity) driver modules arranged in the operating system and Ethernet Media Link control/OSI Physical layer arranged in the operating system and coupled to the WiFi driver modules.

Another purpose of the invention is to provide a dual configuration storage unit which stores data simultaneously both in the master storage unit and the backup storage unit to insure data security without an unrecoverable situation caused by the corruption of the master storage unit. Therefore, the dual configuration storage unit of the invention may achieve double insurance and integrity of data and handle configuration data errors effectively.

The operating process of the present invention includes reading data in the master storage unit first when the portable communication device reads data, confirming data without errors, and then entering the operating system successfully. However, when the data in the master storage unit are corrupted, the portable communication device will copy data in the backup storage unit to the master storage unit automatically and replace all the data therein. The portable communication device will reenter the master storage unit to read data and complete the boot-up operation of the portable communication device smoothly if the copied data are correct. When the copied data are also unreadable, it indicates that there are bad blocks in the master storage unit and at this time the portable communication device will replace the master storage unit with the backup storage unit actively to be the storage unit which the portable communication device reads. The portable communication device rereads information in the backup storage unit to perform boot-up operations and completes boot up if information in the backup storage unit is correct. Otherwise, it indicates that configuration information in the backup storage unit is also corrupted.

### BRIEF DESCRIPTION OF THE DRAWINGS

The present invention may be understood by some preferred embodiments and detailed descriptions in the specification and the attached drawings below. However, it should be appreciated that all the preferred embodiments of the invention are only for illustrating but not for limiting the scope of the Claims and wherein:

FIG. 1 is a system architecture diagram that illustrates a portable communication device with a dual configuration storage unit in accordance with the present invention.

FIG. 2 is an architecture diagram that illustrates a flash memory of the dual configuration storage unit in accordance with the present invention.

FIG. 3 is a flow diagram that illustrates reading internal data by the portable communication device in accordance with the present invention.

FIG. 4 is a flow diagram that illustrates copying data in the backup storage unit to the master storage unit in accordance with the present invention.

FIG. 5 is a flow diagram that illustrates judging whether or not there are bad blocks in the master storage unit and the backup storage unit in accordance with the present invention.

### DETAILED DESCRIPTION OF THE PREFERRED EMBODIMENT

The invention will now be described with the preferred embodiments and aspects and these descriptions interpret systems, means, and methods of the invention only for illustrating but not for limiting the Claims of the invention. Therefore, except the preferred embodiments in the specification, the present invention may also be widely used in other embodiments.

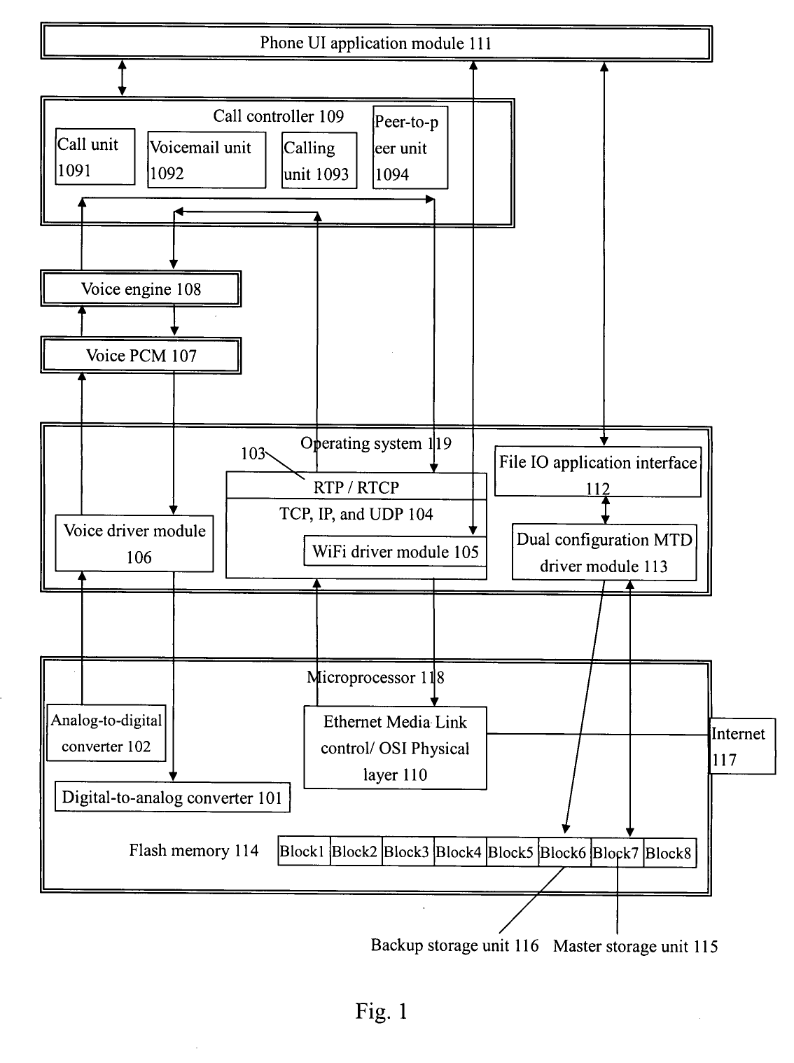

Please refer to FIG. 1 which is shown only for illustrating a preferred embodiment of the invention but not for limiting the invention. FIG. 1 is a system architecture diagram that illustrates a portable communication device with a dual configuration storage unit in accordance with the present invention. The dual configuration storage unit of the invention may be any kinds of flash memories and is not intended to apply in the portable communication device only, that is, the dual configuration storage unit is also adequate for other communication devices to achieve effective data recovery.

As illustrated in FIG. 1, the portable communication device with the dual configuration storage unit of the invention at least includes a master storage unit 115 and a backup storage unit 116.

The portable communication device is compatible to the VoIP (Voice over Internet Protocol) and WiFi standard to enjoy wider bandwidth such that the portable communication device may simultaneously process multi-tasks, for instance, file transmitting, web browsing, and communication to fit wide band and high speed requirements. Noticeably, the portable communication device of the invention at least includes a master storage unit 115 and a backup storage unit 116.

When a user communicates with a remote party through the portable communication device, the digital voice signal converted from the analog voice signal by the analog-to-digital converter 102 is stored into a Voice PCM (Voice Phase Change Memory) 107 via a voice driver module 106. Then, the voice engine 108 reads the digital voice data from the Voice PCM 107 and transmits voice packets to a call controller 109.

Subsequently, the user selects a proper program through a Phone UI application module 111. The call controller 109 includes a call unit 1091, a voicemail unit 1092, a calling unit 1093, and a peer-to-peer unit 1094 therein as voice control and media. The voice engine 108 coupled to the call controller 109 transmits voice packets to the call controller 109. The Phone UI application module 111 communicates with the call controller 109 through instructions and events. Voice packets are transmitted to the call unit 1091 by the call controller 109 and then to the calling unit 1093 through the voicemail unit 1092. Finally, the call controller 109 utilizes the peer-to-peer unit 1094 to connect the desired remote party via the aforementioned voice control and media procedures.

The peer-to-peer unit 1094 drives the RTP and RTCP 103 via an operating system 119 such as LINUX operating system. After the peer-to-peer unit 1094 further drives the TCP, IP, and UDP protocols 104, the Phone UI application module 111 drives the WiFi driver module 105 through WiFi configuration and monitoring, then transmits voice packets into the microprocessor 118 (e.g. TI OMAP 1710 for illustrating but not for limiting the invention), connects internet 117 through Ethernet Media Link control/OSI Physical layer 110, and then transmits voice packets of the user's call to the communication device of the remote party through internet 117.

The Phone UI application module 111 drives the File 10 application interface 112 through read or write instructions from the configuration. Then, the dual configuration MTD driver module 113 executes operations concerned with the flash memory which will be described in the embodiments below.

Through a converse processing procedure, the receiver of the remote party receives voice packets via internet 117, followed by converting the digital voice signal to the analog voice signal via the digital-to-analog converter 101 so as to complete the voice communication between the two parties.

The technology solution provided in the present invention is to take a manner of a dual configuration storage unit with a master storage unit and a backup storage unit as illustrated in FIG. 1. The portable communication device executes reading or writing data via the File 10 application interface 112 and drives the storage unit on the flash memory 114 via the dual configuration MTD driver module 113. There are many subblocks on the flash memory 114 and the present invention occupies two subblocks therein as the master storage unit 115 and the backup storage unit 116. When performing data reading, the portable communication device will simultaneously perform storing and modifying the master storage unit 115 and the backup storage unit 116 to remain consistency and integrity of the data in the master storage unit 115 and the backup storage unit 116.

Referring to FIG. 1, when the portable communication device is down or the data in the master storage unit 115 are corrupted, data in the backup storage unit 116 will perform a recover action to recover the portable communication device to the original setting condition to achieve data recoverability and mobile phone's convenience.

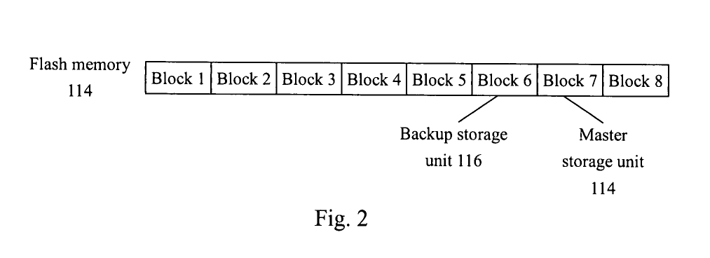

With reference to FIG. 2, in the preferred embodiment, the dual configuration storage unit occupies two subblocks on the flash memory 114 as the master storage unit 115 and the backup storage unit 116.

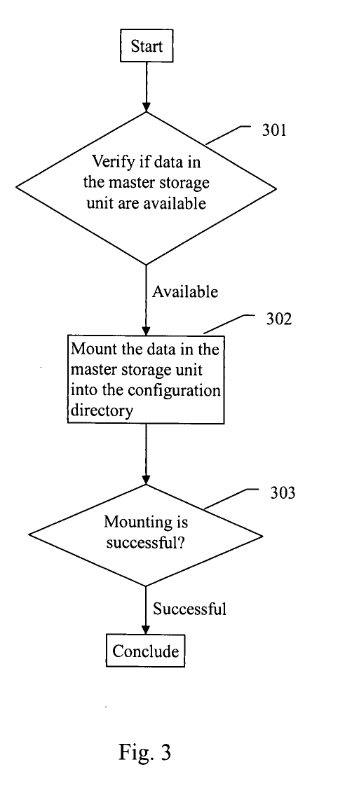

FIG. 3 is a flow diagram of a method that illustrates how the configuration reads data in the master storage unit 115 in accordance with one embodiment. This method and other methods are described as serially arranged modules. However, the modules in the method may be rearranged or arranged appropriately similarly.

As shown in FIG. 3, it starts in the dual configuration MTD driver module 113 and illustrates a correct situation in which the portable communication device reads the storage unit. When commanded to read information in the storage unit, the dual configuration MTD driver module 113 will verify whether or not the data in the master storage unit 115 are available, as Step 301 in FIG. 3. If the data in the master storage unit 115 are available, go to Step 302 next where the data in the master storage unit will be mounted into the configuration directory. If mounting into the configuration directory is successful, the configuration will send back a “correct” instruction to the dual configuration MTD driver module 113 to inform that the configuration directory of the portable communication device is correct to perform associated data reading and modifying operations.

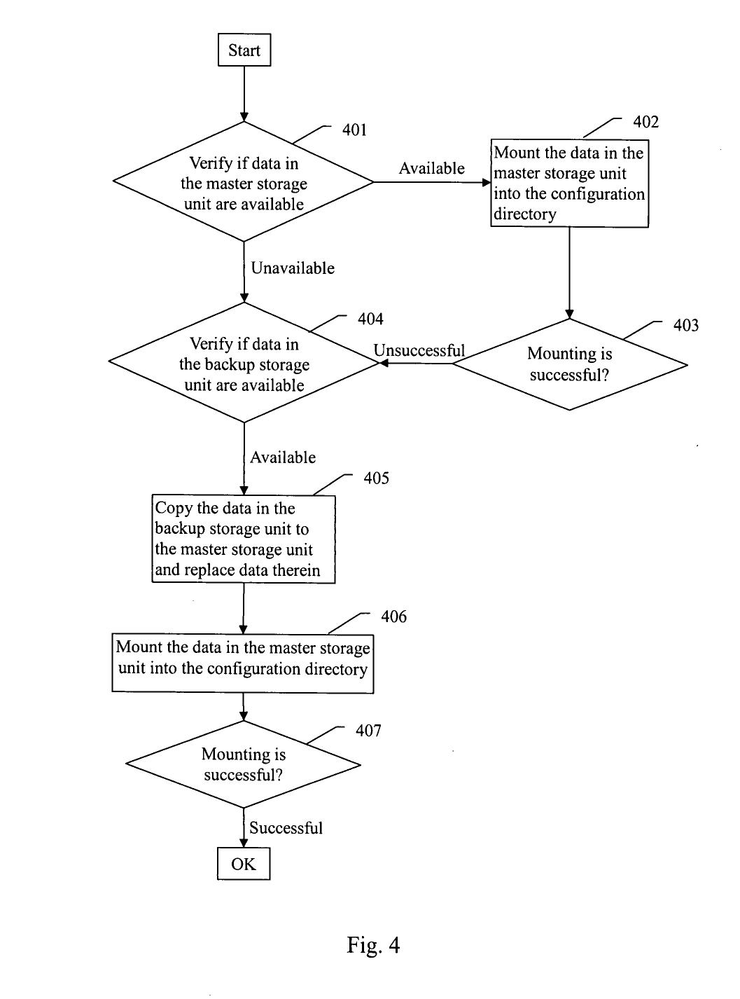

As shown in FIG. 4, it illustrates the step procedures performed when there are corruption errors of the data in the master storage unit 115 with result of not being able to mount the data into the configuration directory so that the data in the backup storage unit 116 are copied to the master storage unit 115 and replace the original.

With reference to FIG. 4, after the portable communication device boots up, its dual configuration MTD driver module 113 gives a read instruction to start verifying whether or not the data in the master storage unit 115 are available and workable, as Step 401 in FIG. 4. If the data are unavailable or unworkable after confirmation, the portable communication device then verifies whether or not the data in the backup storage unit 116 are available and workable, as Step 404. If the data in the backup storage unit 116 are available after confirmation, go to Step 405 where the data in the backup storage unit 116 will be copied to the master storage unit 115 to replace the original. Because the data in the backup storage unit 116 and those in the master storage unit 115 are identical, data recovery actions may be performed for the master storage unit 115.

Referring to FIG. 4, in Step 406 of the operation procedure, the recovered data in the master storage unit 115 are mounted into the configuration directory of the portable communication device and if successful, a “correct” instruction message will be sent back to inform that the data in the portable communication device are available and may be executed correctly.

With reference to FIG. 4, one preferred embodiment is in Step 401 in FIG. 4. If the data in the master storage unit 115 are available and workable, the procedure will go to Step 402 where the data in the master storage unit 115 will be mounted into the portable communication device. Once the mounting fails, go to the aforementioned Step 404 and perform verifying whether or not the data in the backup storage unit 116 are available and workable. If the data are available and workable after confirmation, the data in the backup storage unit 116 will be copied to the master storage unit 115 and replace the original, as Step 405. Repeat the aforementioned step 406 again where the recovered data will be mounted into the portable communication device and if successful, a “correct” instruction will be issued.

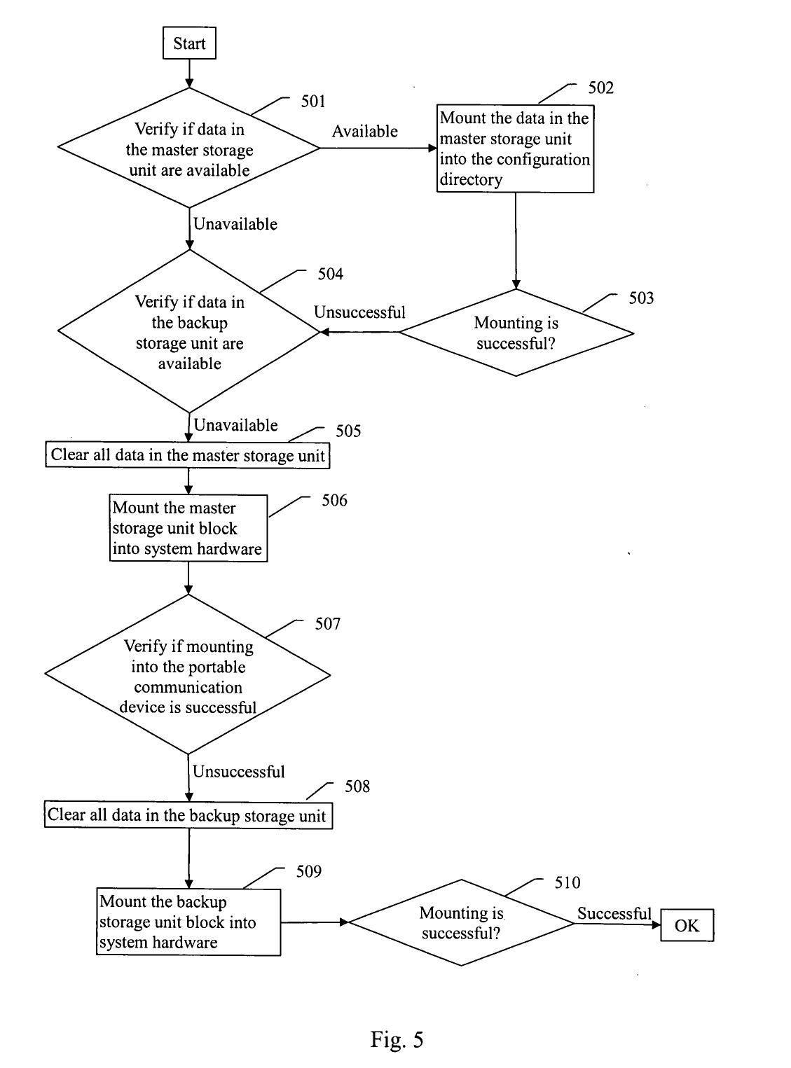

FIG. 5 is a flow diagram in accordance with one preferred embodiment illustrating that there are bad blocks both in the master storage unit 115 and the backup storage unit 116 on the flash memory 114 with result of missing of all associated data on the flash memory 114 so that the portable communication device may not perform associated read operations.

With reference to FIG. 5, in the operation procedure, the dual configuration MTD driver module 113 verifies whether or not the data in the master storage unit 115 are available and workable, as Step 501. If the data are unavailable, the dual configuration MTD driver module 113 then verifies whether or not the data in the backup storage unit 116 are available, as Step 504. When the above two steps (Step 501 and 504) come out unavailable and inexecutable, the master storage unit 115 and the backup storage unit 116 on the flash memory 114 could both be corrupted possibly.

Referring to FIG. 5, in the aforementioned embodiment (Step 501), the data in the master storage unit 115 will be mounted into the portable communication device if confirmed to be available so as to verify whether or not the mounting may be successful (Step 502 and 503). If the mounting fails, the configuration verifies whether or not the data in the backup storage unit 116 are available (Step 504).

Meanwhile, if the data in the master storage unit 115 and those in the backup storage unit 116 both fail to be mounted into the configuration directory of the portable communication device, it indicates that there may be bad blocks both in the master storage unit 115 and the backup storage unit 116 on the flash memory 114. At this time, the configuration may judge whether or not there are bad blocks in the master storage unit 115 and in the backup storage unit 116 on the flash memory 114 and perform the following steps. Initially, clear all the data in the master storage unit 115 to make the master storage unit 115 blank (Step 505). Subsequent step is to mount the master storage unit 115 into the flash memory 114 to verify whether or not the master storage unit 115 may be mounted successfully (Step 506 and 507). If it fails, it indicates that there are bad blocks in the aforementioned subblock on the flash memory 114 in FIG. 2, so that the master storage unit 115 could not be mounted into configuration interfaces.

In the aforementioned embodiment, after the master storage unit 115 fails to be mounted into the portable communication device (Step 507), the configuration then verifies whether or not the same situation exists in the backup storage unit 116. All the data in the backup storage unit 116 will be cleared (Step 508) and the blank backup storage unit 116 will be mounted into the flash memory 114 (Step 509). Then, whether or not the backup storage unit 116 is successfully mounted will be confirmed (Step 4510). If it comes out unsuccessful, it indicates that there may be bad blocks in the backup storage unit 116. The aforementioned steps for verifying the master storage unit 115 and the backup storage unit 116 may be exchanged.

With reference to FIG. 5, in the preferred embodiment, there may be a possibility of bad blocks both in the master storage unit 115 and the backup storage unit 116 on the flash memory 114. In the case, the dual configuration MTD driver module 113 will send back an “error” message to inform the Phone UI application module 111 that the reading and modifying actions can not be performed to the master storage unit 115 and the backup storage unit 116. Therefore, the portable communication device can only be sent back to the original manufacturer to be repaired.

In the aforementioned embodiments, the dual configuration storage unit apparently can perform data recovery actions rapidly to insure the configuration data correctness. Data in the single storage unit in the conventional technology is unrecoverable if corrupted so that the only solution is to send back to the manufacturer. The present invention may provide better information assurance and solve the problem of data corruption effectively.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the invention. It is intended that all such modifications and alterations are included insofar as they come within the scope of the invention as claimed or the equivalents thereof.

What is claimed is:

1. A portable communication device, comprising:
a microprocessor arranged in the portable communication device;
a dual configuration storage unit embedded in the microprocessor to store data therein, the dual configuration storage unit including a master storage unit and a backup storage unit;
an operating system coupled to the microprocessor;
a Phone UI application module coupled to the operating system for a user to input instructions;
a dual configuration MTD driver module installed in the operating system as communication between the Phone UI application module and the dual configuration storage unit;
a converter arranged in the portable communication device as transformation between an analog signal and a digital signal;
a voice engine coupled to the operating system as a signal transmission medium; and
a call controller coupled to the voice engine to communicate with the Phone UI application module through instructions and events.

2. The portable communication device of claim 1, wherein the master storage unit is embedded in a flash memory for storing data and performing reading and modifying actions to the data.

3. The portable communication device of claim 1, wherein the backup storage unit is embedded in a flash memory for backuping data in the master storage unit, data in the backup storage unit being identical to those in the master storage unit.

4. The portable communication device of claim 1, further comprising:
WiFi driver modules arranged in the operating system; and
Ethernet Media Link control/OSI Physical layer arranged in the operating system and coupled to the WiFi driver modules.

5. A dual configuration storage unit, comprising:
a master storage unit embedded in a flash memory for storing data in the portable communication device and performing reading and modifying actions to the data; and
a backup storage unit embedded in the flash memory for backuping data in the master storage unit, data in the backup storage unit being identical to those in the master storage unit.

6. The dual configuration storage unit of claim 5, wherein data are stored into the master storage unit and the backup storage unit simultaneously during data writing.

7. The dual configuration storage unit of claim 5, wherein data are modified and stored into the master storage unit and the backup storage unit simultaneously during data writing and modifying.

8. The dual configuration storage unit of claim 5, wherein data are read from the master storage unit first during data writing and reading.

9. The dual configuration storage unit of claim 5, wherein data in the backup storage unit are copied to the master storage unit and replace those in the master storage unit to perform data recovery when the data in the master storage unit are corrupted.

10. A method applied to a portable communication device for reading a dual configuration storage unit, the portable communication device including the dual configuration storage unit having a master storage unit and a backup storage unit, the method comprising:
verifying whether or not data in the master storage unit are available;
verifying whether or not data in the backup storage unit are available if the aforementioned verification is unavailable, copying the data in the backup storage unit to the master storage unit if the aforementioned verification is available; and
mounting the master storage unit into the portable communication device.

11. The method of claim 10, if the data in the backup storage unit are confirmed to be unavailable, further comprising:
clearing the data in the master storage unit;
mounting the master storage unit into the portable communication device; and
determining whether the mounting is successful.

12. The method of claim 10, if the data in the backup storage unit are confirmed to be unavailable, further comprising:
clearing the data in the backup storage unit;
mounting the backup storage unit into the portable communication device; and
determining whether the mounting is successful.
